(19) United States
(12) Patent Application Publication
(10) Pub. No.: US 2012/0155887 A1
(43) Pub. Date: Jun. 21, 2012

(54) METHOD AND APPARATUS FOR TRANSMITTING AND RECEIVING COHERENT OPTICAL OFDM

(75) Inventors: Chun Ju YOUN, Daejeon (KR); Yong-Hwan Kwon, Daejeon (KR); Duk Jun Kim, Daejeon (KR); Jong-Hoi Kim, Daejeon (KR); Joong-Seon Choe, Daejeon (KR); Kwang-Seong Choi, Daejeon (KR); Eun Soo Nam, Daejeon (KR)

(73) Assignee: ELECTRONICS AND TELECOMMUNICATIONS RESEARCH INSTITUTE, Daejeon (KR)

(21) Appl. No.: 13/301,814

(22) Filed: Nov. 22, 2011

(30) Foreign Application Priority Data
Dec. 17, 2010 (KR) 10-2010-0129923

(51) Int. Cl. H04B 10/06; H04B 10/04

(52) U.S. Cl. 398/182; 398/202; 398/208

(57) ABSTRACT

Disclosed are a method and an apparatus for transmitting and receiving coherent optical OFDM. The apparatus includes: a transmitted OFDM digital signal processing unit outputting an in-phase (I) component digital signal and a quadrature phase (Q) component digital signal; a digital-analog converter converting the in-phase (I)-component digital signal and the quadrature-phase (Q)-component digital signal into an in-phase (I)-component analog signal and a quadrature-phase (Q)-component analog signal, respectively; an adder adding an additional pilot tone signal to each of the in-phase (I)-component analog signal and the quadrature-phase (Q)-component analog signal outputted from the digital-analog converter; and an optical I/Q modulator up-converting the in-phase (I)-component analog signal added with the additional pilot tone signal and the quadrature-phase (Q)-component analog signal added with the additional pilot tone signal to an optical domain to output a coherent optical OFDM signal including the additional pilot tone signal.

### CROSS-REFERENCE TO RELATED APPLICATIONS

This application is based on and claims priority from Korean Patent Application No. 10-2010-0129923, filed on Dec. 17, 2010, with the Korean Intellectual Property Office, the present disclosure of which is incorporated herein in its entirety by reference.

### TECHNICAL FIELD

The present disclosure relates to a method for compensating for phase noise in coherent optical OFDM, and more particularly, to a method and an apparatus for transmitting and receiving coherent optical OFDM that compensate for phase noise of an OFDM data subcarrier by applying an additional pilot tone to a low-frequency band or a high-frequency band where no OFDM data subcarrier exists in an OFDM band, and estimating a phase of the additional pilot tone and multiplying the OFDM data subcarrier by a complex conjugate of the estimated phase.

### BACKGROUND

An optical OFDM technique which applies an OFDM technique to optical communication is evaluated as a technique that has large tolerance in elements deteriorating an optical signal quality, such as chromatic dispersion and polarization mode dispersion of an optical fiber and can easily compensate for the chromatic dispersion and polarization mode dispersion in a receiver. Therefore, various researches into the optical OFDM technique have been performed.

An orthogonal frequency division multiplexing (OFDM) technique is a communication technique that allocates a plurality of subcarriers perpendicular to each other and transmits data through each of the subcarriers at a relatively low symbol rate in order to transmit a signal at a high transmission speed. The OFDM communication technique as a technique that can cope with multiple fading effects with high spectrum efficiency has been generally used in WiMAX, Wireless LAN, ADSL, a digital radio and video broadcasting system.

Meanwhile, in a coherent optical OFDM, a laser beam of a local oscillator having relatively large power and a received signal interfere with each other to be down-converted and are converted into an electrical signal by an optical detector. Phase noise of the laser used during the above process may have a large influence on system performance. Since the symbol rate in the OFDM system is much lower than that of a single carrier system, the OFDM signal may be influenced much more by the phase noise and phase noise compensation requirements may also be more strict. In order to compensate for the influence by the phase noise of the laser, several methods including a method of using OFDM pilot subcarriers and a method using an RF pilot tone are presented.

One method adopts a method of using pilot subcarriers in an OFDM symbol in order to compensate for phase noise of a transmitter and a receiver in the coherent optical OFDM (“Phase Estimation for Coherent Optical OFDM”, IEEE Photonics Technology Letters, Vol. 19, No. 12, pp. 919-921, 2007). In this method, several pilot subcarriers are allocated in addition to the OFDM data subcarriers in an OFDM symbol spectrum and phases of the pilot subcarriers are estimated in the receiver. A phase estimating method using the pilot subcarrier uses a plurality of parallel subcarriers in the OFDM system and is difficult to be implemented in the general single carrier system. Phase variation estimated in one OFDM symbol represents an average value of differences in the received phase and the transmitted phase in the pilot subcarriers. Therefore, by multiplying received OFDM data by a complex conjugate of an estimated phase variation, phase noise of the received OFDM data is compensated. In this method, since it is assumed that the phase variation is uniform in one OFDM symbol, performance deteriorates when noise is generated by rapid phase variation.

Another method adopts a method of compensating phase noise by adding an RF-pilot tone to a middle part (DC) of the OFDM band in the transmitter (“Coherent Optical 25.8-Gb/s OFDM Transmission Over 4160-km SSMF,” IEEE Journal of Lightwave Technology Letter, vol. 26, no. 1, pp. 6-15, 2008). Since the RF-pilot tone is distorted in the completely same manner as an OFDM signal by the phase noise, distortion of the OFDM signal can be compensated. In the method of compensating the phase noise by adding the RF pilot tone, since the RF pilot tone is positioned at the center (DC) of the OFDM signal, additional bandwidth or hardware is not required. Further, since phase noise is compensated in each received sample, the non-uniform phase variation during one OFDM symbol can be compensated.

The present disclosure provides a method of adding the additional pilot tone to not the DC but a frequency range without the OFDM data subcarriers in the OFDM band and compensating for the phase noise per sample unlike the method using the pilot subcarrier among the OFDM data subcarriers.

### SUMMARY

The present disclosure has been made in an effort to provide a method and an apparatus for transmitting and receiving coherent optical OFDM that add an additional pilot tone to not a DC but a frequency range without OFDM data subcarriers in an OFDM band and compensate for phase noise per sample unlike a method using a pilot subcarrier among the OFDM data subcarriers.

An exemplary embodiment of the present disclosure provides an apparatus for transmitting coherent optical OFDM, including: a transmitted OFDM digital signal processing unit outputting an in-phase (I) component digital signal and a quadrature phase (Q) component digital signal; a digital-analog converter converting the in-phase (I)-component digital signal and the quadrature-phase (Q)-component digital signal into an in-phase (I)-component analog signal and a quadrature-phase (Q)-component analog signal, respectively; an adder adding an additional pilot tone signal to each of the in-phase (I)-component analog signal and the quadrature-phase (Q)-component analog signal outputted from the digital-analog converter; and an optical I/Q modulator up-converting the in-phase (I)-component analog signal added with the additional pilot tone signal and the quadrature-phase (Q)-component analog signal added with the additional pilot tone signal to an optical domain to output a coherent optical OFDM signal including the additional pilot tone signal.

Another exemplary embodiment of the present disclosure provides an apparatus for transmitting coherent optical OFDM, including: a transmitted OFDM digital signal processing unit outputting an in-phase (I) component digital signal and a quadrature phase (Q) component digital signal; a digital-analog converter converting the in-phase (I)-component digital signal and the quadrature-phase (Q)-component digital signal into an in-phase (I)-component analog signal and a quadrature-phase (Q)-component analog signal, respectively; a first optical I/Q modulator up-converting the in-phase (I)-component analog signal and the quadrature-phase (Q)-component analog signal outputted from the digital-analog converter to an optical domain to output a coherent optical OFDM signal; a second optical I/Q modulator up-converting an applied additional pilot tone signal to the optical domain to output an additional optical pilot tone signal; and an optical coupler outputting the coherent optical OFDM signal including an additional pilot signal by optically coupling the coherent optical OFDM signal and the additional optical pilot tone signal with each other.

Yet another exemplary embodiment of the present disclosure provides an apparatus for receiving coherent optical OFDM, including: an optical down-converting unit outputting an in-phase (I)-component analog signal and a quadrature-phase (Q)-component analog signal by optically down-converting a coherent optical OFDM signal; an analog-digital converter converting the in-phase (I)-component analog signal and the quadrature-phase (Q)-component analog signal into an in-phase (I)-component digital signal and a quadrature-phase (Q)-component digital signal, respectively; a phase noise compensation digital signal processing unit separating OFDM data and an additional pilot tone signal from each of the in-phase (I)-component digital signal and the quadrature-phase (Q)-component digital signal outputted from the analog-digital converter and multiplying the separated OFDM data by a complex conjugate of additional pilot tone signal to output an OFDM signal in which phase noise is compensated; and a received OFDM data signal processing unit demodulating the OFDM signal in which phase noise is compensated.

Still another exemplary embodiment of the present disclosure provides a method for transmitting coherent optical OFDM, including: converting an in-phase (I) component digital signal and a quadrature phase (Q) component digital signal into an in-phase (I) component analog signal and a quadrature phase (Q) component analog signal, respectively; adding an additional pilot tone signal to each of the in-phase (I)-component analog signal and the quadrature-phase (Q)-component analog signal; and up-converting the in-phase (I)-component analog signal added with the additional pilot tone signal and the quadrature-phase (Q)-component analog signal added with the additional pilot tone signal to an optical domain to generate and transmit a coherent optical OFDM signal including the additional pilot tone signal.

Still yet another exemplary embodiment of the present disclosure provides a method for receiving coherent optical OFDM, including: generating an in-phase (I) component analog signal and a quadrature phase (Q) component analog signal by optically down-converting a received coherent optical OFDM signal; converting the in-phase (I)-component analog signal and the quadrature-phase (Q)-component analog signal into an in-phase (I) component digital signal and a quadrature phase (Q) component digital signal, respectively; separating OFDM data and an additional pilot tone signal from each of the in-phase (I)-component digital signal and the quadrature-phase (Q)-component digital signal and multiplying the separated OFDM data by a complex conjugate of additional pilot tone signal to generate an OFDM signal in which phase noise is compensated; and demodulating the OFDM signal in which phase noise is compensated.

As described above, according to the exemplary embodiments of the present disclosure, by providing a method and an apparatus for transmitting and receiving coherent optical OFDM that compensate phase noise per sample by applying a separate additional pilot carrier without using OFDM pilot carriers, the phase noise can be efficiently compensated even in a OFDM system using a light source with wide linewidth.

By providing the method and apparatus for transmitting and receiving coherent optical OFDM that can apply an additional pilot tone of double-side band or a single-side band to a low-frequency or high-frequency range, phase noise of a laser can be efficiently compensated, and the method and apparatus can be applied to compensation of a frequency offset between a transmission light source and a light source of a local oscillator.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram for describing a method for compensating phase noise in coherent optical OFDM.

FIG. 2 is a diagram showing a schematic configuration of an internal part of an apparatus for transmitting coherent optical OFDM according to a first exemplary embodiment of the present disclosure.

FIG. 3 is a diagram showing a schematic configuration of an internal part of an apparatus for transmitting coherent optical OFDM according to a second exemplary embodiment of the present disclosure.

FIG. 4 is a diagram showing a schematic configuration of an internal part of an apparatus for receiving coherent optical OFDM according to a third exemplary embodiment of the present disclosure.

FIG. 5 is a diagram showing a schematic configuration of an internal part of an apparatus for receiving coherent optical OFDM according to a fourth exemplary embodiment of the present disclosure.

FIG. 6 is a flowchart showing a method for transmitting coherent optical OFDM according to a fifth exemplary embodiment of the present disclosure.

FIG. 7 is a flowchart showing a method for receiving coherent optical OFDM according to a sixth exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

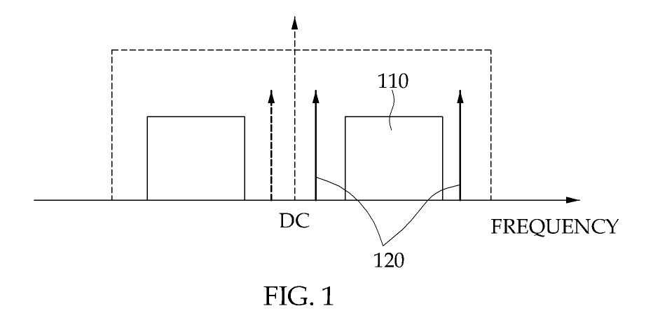

FIG. 1 is a conceptual diagram for describing a method for compensating phase noise in coherent optical OFDM.

Referring to FIG. 1, in the method for compensating phase noise in coherent optical OFDM according to an exemplary embodiment of the present disclosure, an additional pilot tone signal 120 is applied to a low-frequency band or a high-frequency band without an OFDM data subcarrier 110 in a bandwidth. Herein, additional pilot tone signal 120 may be a double side band (DSB) signal or a single side band (SSB) signal. Since additional pilot tone signal 120 is influenced by phase noise such as OFDM data subcarrier 110, a receiver estimates a phase of additional pilot tone signal 120 and OFDM data subcarrier 110 is multiplied by a complex conjugate of the estimated phase to thereby compensate the phase noise of OFDM data subcarrier 110.

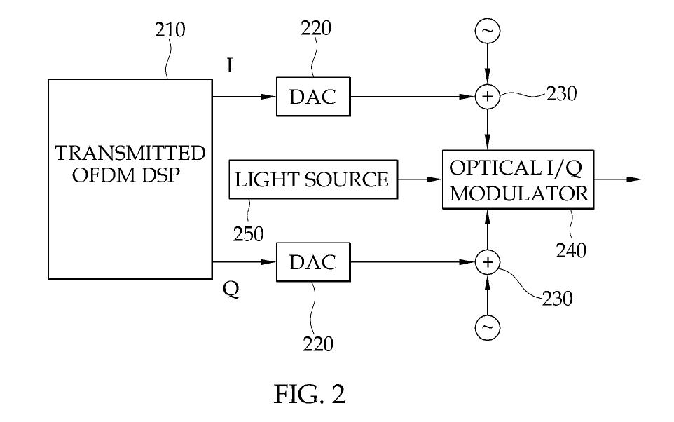

FIG. 2 is a diagram showing a schematic configuration of an internal part of an apparatus for transmitting coherent optical OFDM according to a first exemplary embodiment of the present disclosure.

Referring to FIG. 2, the apparatus for transmitting coherent optical OFDM according to the first exemplary embodiment of the present disclosure includes a transmitted OFDM digital signal processing unit (hereinafter, referred to as a ‘transmitted OFDM DSP’) 210, a digital-analog converter (hereinafter, referred to as a ‘DAC’) 220, an adder 230, an optical I/Q modulator 240, and a light source 250.

Transmitted OFDM DSP 210 generates a transmitter's baseband OFDM signal, that is, an in-phase (I) component digital signal and a quadrature phase (Q) component digital signal.

DAC 220 converts the in-phase (I)-component digital signal and the quadrature-phase (Q)-component digital signal outputted from transmitted OFDM DSP 210, into an in-phase (I)-component analog signal and a quadrature-phase (Q)-component analog signal, respectively.

Adder 230 adds an additional pilot tone signal to each of the in-phase (I)-component analog signal and the quadrature-phase (Q)-component analog signal outputted from DAC 220.

Optical I/Q modulator 240 up-converts the in-phase (I)-component analog signal added with the additional pilot tone signal and the quadrature-phase (Q)-component analog signal added with the additional pilot tone signal to an optical domain by using an optical signal supplied from light source 250 to output a coherent optical OFDM signal including the additional pilot tone signal.

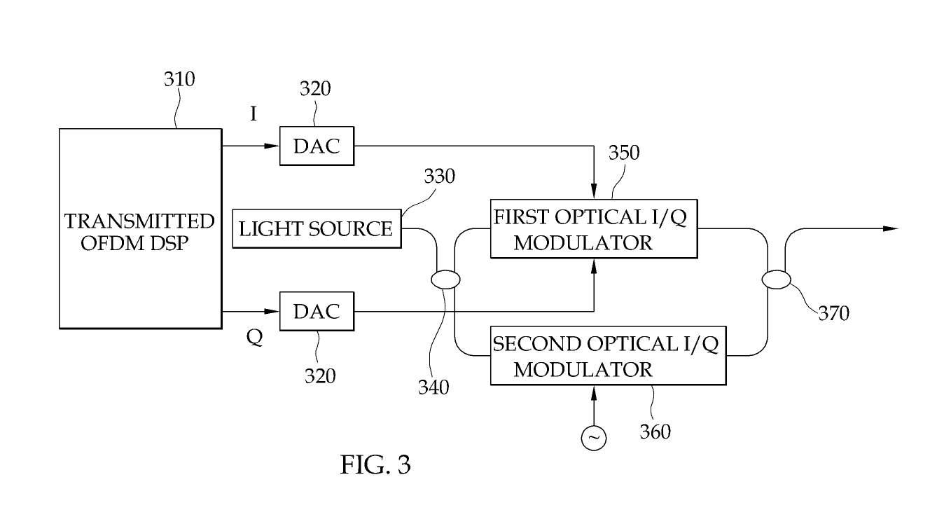

FIG. 3 is a diagram showing a schematic configuration of an internal part of an apparatus for transmitting coherent optical OFDM according to a second exemplary embodiment of the present disclosure.

Referring to FIG. 3, the apparatus for transmitting coherent optical OFDM according to the second exemplary embodiment of the present disclosure includes a transmitted OFDM DSP 310, a DAC 320, a light source 330, a light splitter 340, a first optical I/Q modulator 350, a second I/Q modulator 360, and an optical coupler 370.

Transmitted OFDM DSP 310 generates a transmitter's baseband OFDM signal, that is, an in-phase (I) component digital signal and a quadrature phase (Q) component digital signal.

DAC 320 converts the in-phase (I)-component digital signal and the quadrature-phase (Q)-component digital signal outputted from transmitted OFDM DSP 310, into an in-phase (I)-component analog signal and a quadrature-phase (Q)-component analog signal, respectively.

Light splitter 340 splits an optical signal supplied form light source 330 and provides the split optical signals to first optical I/Q modulator 350 and second optical I/Q modulator 360.

First optical I/Q modulator 350 up-converts an in-phase (I)-component analog signal and a quadrature-phase (Q)-component analog signal outputted from DAC 320 to an optical domain by using the optical signal split by optical splitter 340 to output a coherent optical OFDM signal.

Second optical I/Q modulator 360 up-converts the applied additional pilot tone signal to an optical domain by using the optical signal split by optical splitter 340 to output an additional pilot tone optical signal.

Optical coupler 370 outputs the coherent optical OFDM signal including the additional pilot tone signal by optically coupling the coherent optical OFDM signal and the additional pilot tone optical signal.

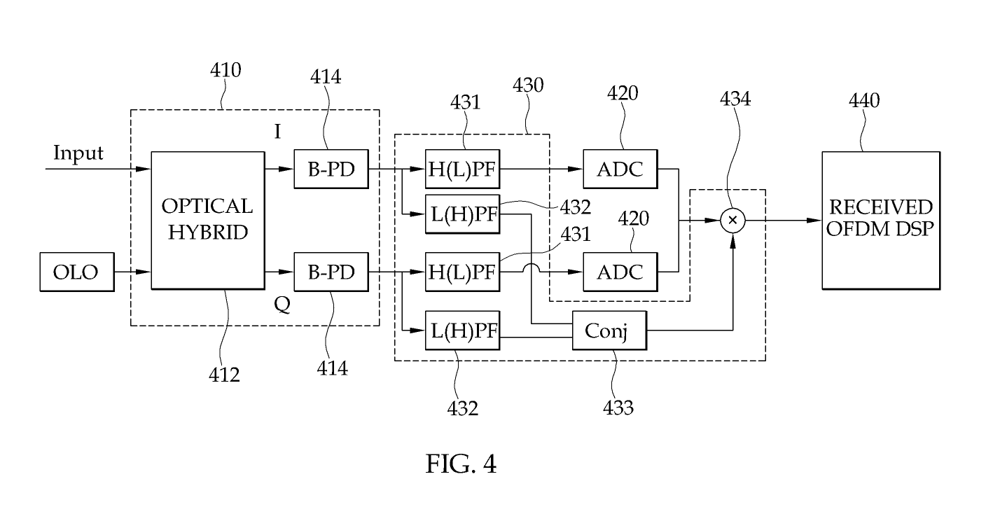

FIG. 4 is a diagram showing a schematic configuration of an internal part of an apparatus for receiving coherent optical OFDM according to a third exemplary embodiment of the present disclosure.

Referring to FIG. 4, the apparatus for receiving coherent optical OFDM according to the third exemplary embodiment of the present disclosure includes an optical down-converting unit 410, an analog-digital converter (hereinafter, referred to as an ‘ADC’) 420, a phase noise compensation digital signal processing unit (hereinafter, referred to as a ‘phase noise compensation DSP’) 430, and a received OFDM digital signal processing unit (hereinafter, referred to as a ‘received OFDM DSP’) 440.

Optical down-converting unit 410 outputs an in-phase (I)-component analog signal and a quadrature-phase (Q)-component analog signal by optically down-converting a coherent optical OFDM signal. To this end, optical down-converting unit 410 may include an optical hybrid 412 outputting the coherent optical OFDM signal into an in-phase (I)-component optical signal and a quadrature-phase (Q)-component optical signal and an optical detector (B-PD) 414 optically down-converting the in-phase (I)-component optical signal and the quadrature-phase (Q)-component optical signal.

ADC 420 converts the in-phase (I)-component analog signal and the quadrature-phase (Q)-component analog signal into an in-phase (I)-component digital signal and a quadrature-phase (Q)-component digital signal, respectively.

Phase noise compensation DSP 430 separates OFDM data and an additional pilot tone signal from each of the in-phase (I)-component digital signal and the quadrature-phase (Q)-component digital signal outputted from ADC 420 and multiplies the separated OFDM data by complex conjugate of additional pilot tone signal to output an OFDM signal in which phase noise is compensated. To this end, phase noise compensation DSP 430 may include a high-pass filter (HPF) 431, a low-pass filter (LPF) 432, a complex conjugate numberer 433, and a multiplier 434. In the exemplary embodiment of the present disclosure, when a high-frequency additional pilot tone signal is used, high-pass filter 431 is substituted with the low-pass filter and low-pass filter 432 is substituted with the high-pass filter.

Received OFDM DSP 440 demodulates the OFDM signal in which phase noise is compensated.

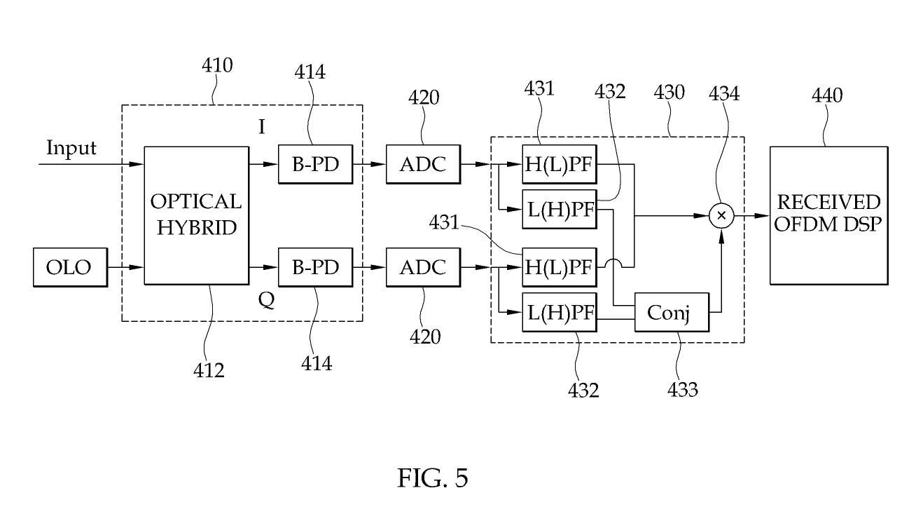

FIG. 5 is a diagram showing a schematic configuration of an internal part of an apparatus for receiving coherent optical OFDM according to a fourth exemplary embodiment of the present disclosure.

Referring to FIG. 5, internal components of the apparatus for receiving coherent optical OFDM according to the fourth exemplary embodiment of the present disclosure are the same components as the apparatus for receiving coherent optical OFDM of FIG. 4, but high-pass filter 431 and low-pass filter 432 for separating the OFDM data and the additional pilot tone signal are configured by not digital filters but analog filters. Therefore, high-pass filter 431 and low-pass filter 432 configured by the analog filters may be positioned at a preceding stage of ADC 420.

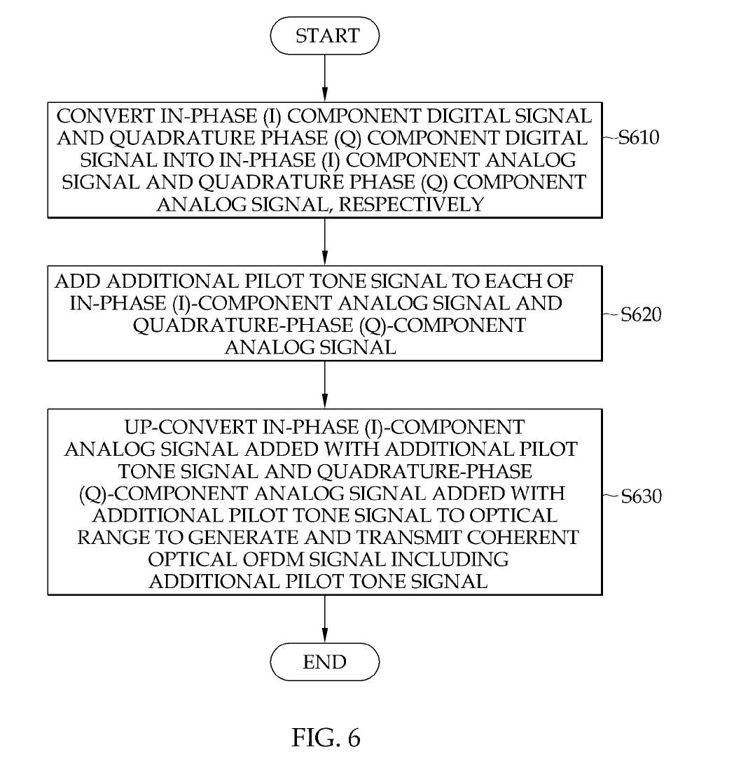

FIG. 6 is a flowchart showing a method for transmitting coherent optical OFDM according to a fifth exemplary embodiment of the present disclosure.

Referring to FIG. 6, an in-phase (I)-component digital signal and a quadrature-phase (Q)-component digital signal are converted into an in-phase (I)-component analog signal and a quadrature-phase (Q)-component analog signal, respectively (S610).

An additional pilot tone signal is added to each of the in-phase (I)-component analog signal and the quadrature-phase (Q)-component analog signal (S620). Herein, the additional pilot tone signal is present in a low-frequency or high-frequency band which is not overlapped with one or more OFDM data subcarrier bands and the additional pilot tone signal may be a double-side band (DSB) signal or a single-side band (SSB) signal.

The in-phase (I)-component analog signal added with the additional pilot tone signal and the quadrature-phase (Q)-component analog signal added with the additional pilot tone signal are up-converted to an optical domain to generate and transmit a coherent optical OFDM signal including the additional pilot tone signal (S630).

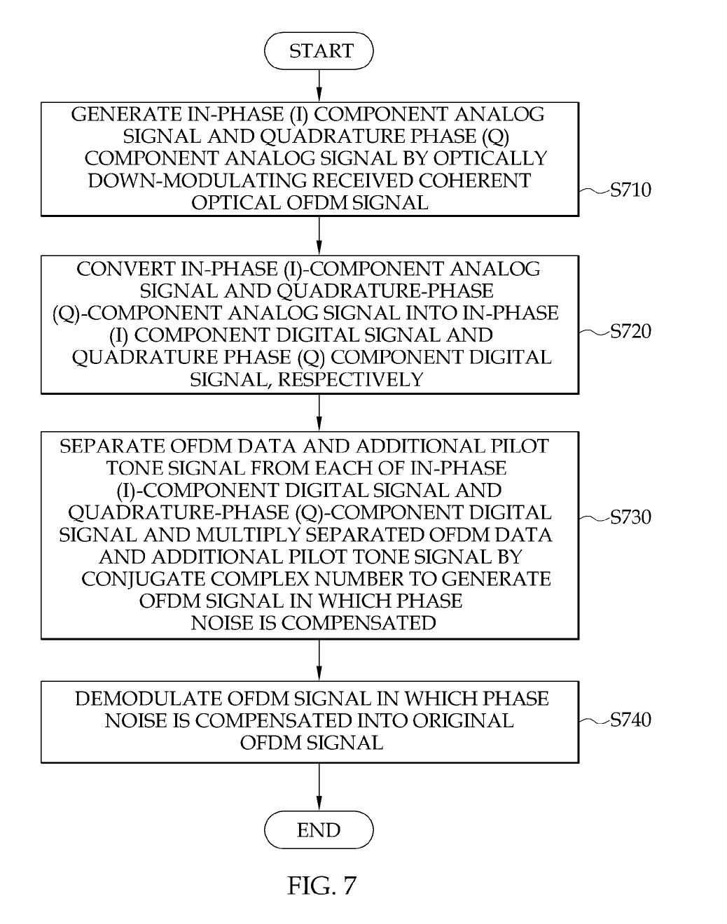

FIG. 7 is a flowchart showing a method for receiving coherent optical OFDM according to a sixth exemplary embodiment of the present disclosure.

Referring to FIG. 7, a received coherent optical OFDM signal is optically down-converted to generate an in-phase (I)-component analog signal and a quadrature-phase (Q)-component analog signal (S710).

The in-phase (I)-component analog signal and the quadrature-phase (Q)-component analog signal are converted into an in-phase (I)-component digital signal and a quadrature-phase (Q)-component digital signal, respectively (S720).

OFDM data and an additional pilot tone signal are separated from each of the in-phase (I)-component digital signal and the quadrature-phase (Q)-component digital signal and the separated OFDM data are multiplied by a complex conjugate of additional pilot tone to generate an OFDM signal in which phase noise is compensated (S730).

The OFDM signal in which phase noise is compensated is demodulated in the original OFDM digital signal processing (S740).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for transmitting coherent optical OFDM, comprising:
a transmitted OFDM digital signal processing unit outputting an in-phase (I) component digital signal and a quadrature phase (Q) component digital signal;
a digital-analog converter converting the in-phase (I)-component digital signal and the quadrature-phase (Q)-component digital signal into an in-phase (I)-component analog signal and a quadrature-phase (Q)-component analog signal, respectively;
an adder adding an additional pilot tone signal to each of the in-phase (I)-component analog signal and the quadrature-phase (Q)-component analog signal outputted from the digital-analog converter; and
an optical I/Q modulator up-converting the in-phase (I)-component analog signal added with the additional pilot tone signal and the quadrature-phase (Q)-component analog signal added with the additional pilot tone signal to an optical domain to output a coherent optical OFDM signal including the additional pilot tone signal.

2. The apparatus of claim 1, wherein the additional pilot tone signal is present in a low-frequency or high-frequency band which is not overlapped with one or more OFDM data subcarrier bands.

3. The apparatus of claim 1, wherein the additional pilot ton signal may be a double side band (DSB) signal or a single side band (SSB) signal.

4. An apparatus for transmitting coherent optical OFDM, comprising:
a transmitted OFDM digital signal processing unit outputting an in-phase (I) component digital signal and a quadrature phase (Q) component digital signal;
a digital-analog converter converting the in-phase (I)-component digital signal and the quadrature-phase (Q)-component digital signal into an in-phase (I)-component analog signal and a quadrature-phase (Q)-component analog signal, respectively;
a first optical I/Q modulator up-converting the in-phase (I)-component analog signal and the quadrature-phase (Q)-component analog signal outputted from the digital-analog converter to an optical domain to output a coherent optical OFDM signal;
a second optical I/Q modulator up-converting an applied additional pilot tone signal to the optical domain to output an additional pilot tone optical signal; and
an optical coupler outputting the coherent optical OFDM signal including an additional pilot signal by optically coupling the coherent optical OFDM signal and the additional pilot tone optical signal with each other.

5. The apparatus of claim 4, wherein the additional pilot tone signal is present in a low-frequency or high-frequency band which is not overlapped with one or more OFDM data subcarrier bands.

6. The apparatus of claim 4, wherein the additional pilot ton signal may be a double side band (DSB) signal or a single side band (SSB) signal.

7. An apparatus for receiving coherent optical OFDM, comprising:
an optical down-converting unit outputting an in-phase (I)-component analog signal and a quadrature-phase (Q)-component analog signal by optically down-converting a coherent optical OFDM signal;
an analog-digital converter converting the in-phase (I)-component analog signal and the quadrature-phase (Q)-component analog signal into an in-phase (I)-component digital signal and a quadrature-phase (Q)-component digital signal, respectively;
a phase noise compensation digital signal processing unit separating OFDM data and an additional pilot tone signal from each of the in-phase (I)-component digital signal and the quadrature-phase (Q)-component digital signal outputted from the analog-digital converter and multiplying the separated OFDM data by complex conjugate of additional pilot tone signal to output an OFDM signal in which phase noise is compensated; and
a received OFDM data signal processing unit demodulating the OFDM signal in which phase noise is compensated.

8. The apparatus of claim 7, wherein the optical down-converting unit includes:
an optical hybrid outputting the coherent optical OFDM signal into an in-phase (I)-component optical signal and a quadrature-phase (Q)-component optical signal; and
an optical detector optically down-converting the in-phase (I)-component optical signal and the quadrature-phase (Q)-component optical signal.

9. The apparatus of claim 7, wherein the phase noise compensation digital signal processing unit includes a high-pass filter, a low-pass filter, a conjugate complex numberer, and a multiplier.

10. The apparatus of claim 9, wherein the high-pass filter and the low-pass filter is a digital filter or an analog filter.

11. A method for transmitting coherent optical OFDM, comprising:
converting an in-phase (I) component digital signal and a quadrature phase (Q) component digital signal into an in-phase (I) component analog signal and a quadrature phase (Q) component analog signal, respectively;
adding an additional pilot tone signal to each of the in-phase (I)-component analog signal and the quadrature-phase (Q)-component analog signal; and
up-converting the in-phase (I)-component analog signal added with the additional pilot tone signal and the quadrature-phase (Q)-component analog signal added with the additional pilot tone signal to an optical domain to generate and transmit a coherent optical OFDM signal including the additional pilot tone signal.

12. The method of claim 11, wherein the additional pilot tone signal is present in a low-frequency or high-frequency band which is not overlapped with one or more OFDM data subcarrier bands.

13. The method of claim 11, wherein the additional pilot ton signal may be a double side band (DSB) signal or a single side band (SSB) signal.

14. A method for receiving coherent optical OFDM, comprising:
generating an in-phase (I) component analog signal and a quadrature phase (Q) component analog signal by optically down-converting a received coherent optical OFDM signal;
converting the in-phase (I)-component analog signal and the quadrature-phase (Q)-component analog signal into an in-phase (I) component digital signal and a quadrature phase (Q) component digital signal, respectively;
separating OFDM data and an additional pilot tone signal from each of the in-phase (I)-component digital signal and the quadrature-phase (Q)-component digital signal and multiplying the separated OFDM data by complex conjugate of additional pilot tone signal to generate an OFDM signal in which phase noise is compensated; and
demodulating the OFDM signal in which phase noise is compensated.
